(19) United States
(12) Patent Application Publication
(10) Pub. No.: US 2009/0100666 A1
(43) Pub. Date: Apr. 23, 2009

(54) METHOD OF INSTALLING OF ANTENNAS OF A NOTEBOOK

(76) Inventors: Daniel CHANG, Pa-Te City (TW); Chia-Lun Tang, Pa-Te City (TW)

Correspondence Address: SINORICA, LLC, 528 FALLSGROVE DRIVE, ROCKVILLE, MD, 20850, US

(21) Appl. No.: 11/876,576

(22) Filed: Oct. 22, 2007

(51) Int. Cl. H01P 11/00

(52) U.S. Cl. 29/600; 29/601; 343/700 MS

(57) ABSTRACT

A method of installation of notebook antennas, the method is mainly to design to use a mode of manufacturing labels to make groups of or integrate antennas required by the notebook to make a label type antenna; then the label type antenna is stuck and fixed on an inner layer of the housing of the notebook. This method can reduce cost of manufacturing and thickness and weight of notebooks.

### BACKGROUND OF THE INVENTION

1. Field of the Invention

The present invention relates to a method of installing antennas, and especially to a method of manufacturing a plurality of antennas of different bandwidths and sticking the same on an inner layer of the housing of a notebook.

2. Description of the Prior Art

Following fast development of the wireless communication technique, various wireless communication systems has their respective applicable ranges of frequency. The ranges of frequency of the notable Global Positioning System (GPS) are: L1 band using 1575.42 MHz, L2 band using 1227.60 MHz; the range of frequency of Global System for Mobile Communication (GSM) is: 890˜960 MHz; the range of frequency of Digital Communication System (DCS) is 1710˜1880 MHz; the range of frequency of Personal Communication Service (PCS) is 1850˜1990 MHz; the range of frequency of Integration of Mobile and Fixed Network (IMT-2000 (3G)) is 1920˜2170 MHz; the range of frequency of the Bluetooth is 2440˜2484 MHz (IEEE 802.11b); and the range of frequency of the Ultra Wideband Communication (UWB) is 3.1˜10.6 MHz. (Note: these ranges of frequency may be slightly different in pursuance of different districts).

By the fact that each kind of wireless communication system has its own range of frequency, the equipment of mobile communication must uses matched antennas designed in accordance with their own ranges of frequency.

And following large increasing of ability of notebooks in the present days, the notebooks can be in the built-in type applicable to all the mobile communication equipment; to meet different wireless communication systems, there must be various antennas in order to be provided in the housings of notebooks. Under the requirement of compactness on notebooks, the antennas installed in the notebooks mainly are planar antennas.

The method of installation of an antenna in a conventional notebook is to make a planar antenna from metallic sheets, and then to fix the antenna in the housings of the notebook, for instance in a housing around a display screen, by using fixing means such as using screws.

Such a method of installation must induces increasing of working hour for installation process when an antenna is applied to a plurality of ranges of frequency; and by the fact that the fixing means such as using screws makes a notebook thicker and heavier, it is contrary to the requirement for compactness, thus improvement is wanted.

### SUMMARY OF THE INVENTION

In view of the defects resided in the method of installation of notebook antennas of the conventional notebooks, the present invention provides a brand new technique of antenna installation that can make easy and fast installation of a plurality of antennas with different ranges of frequency, and can reduce cost and thickness and weight of notebooks.

The method of installation of notebook antennas of the present invention is mainly to design to use a mode of manufacturing labels to make groups of or integrate antennas required by the notebook, thus a label type antenna is made; then the label type antenna is stuck and fixed on an inner layer of the housing of the notebook.

The method of installation of notebook antennas of the present invention can combine signal lines of each antenna into one soft bus line in favor of connecting to one of various kinds of communication equipment.

The method of installation of notebook antennas of the present invention can make an antenna with a monolayer or multiple layers.

The method of installation of notebook antennas of the present invention can further have the antennas left with at least an opening to make spaces for peripheral equipment (such as a camera module, a set of horns etc.) of the notebook.

The present invention will be apparent after reading the detailed description of the preferred embodiment thereof in reference to the accompanying drawings.

### BRIEF DESCRIPTION OF THE DRAWINGS

FIG. 1 shows the first step of making a label type antenna of the present invention;

FIG. 2 shows that the label type antenna of the present invention is stuck on of a periphery of a notebook;

FIG. 3 shows a pattern diagram of 3D field type obtained by a simulation test.

### DETAILED DESCRIPTION OF THE PREFERRED EMBODIMENT

The method of installation of notebook antennas of the present invention includes the following steps:
a) to design to use a mode of manufacturing labels to make groups of or integrate a plurality of antennas required by the notebook, thus to make a label type antenna; and
b) then to stick and fix the label type antenna on an inner layer of the housing of the notebook

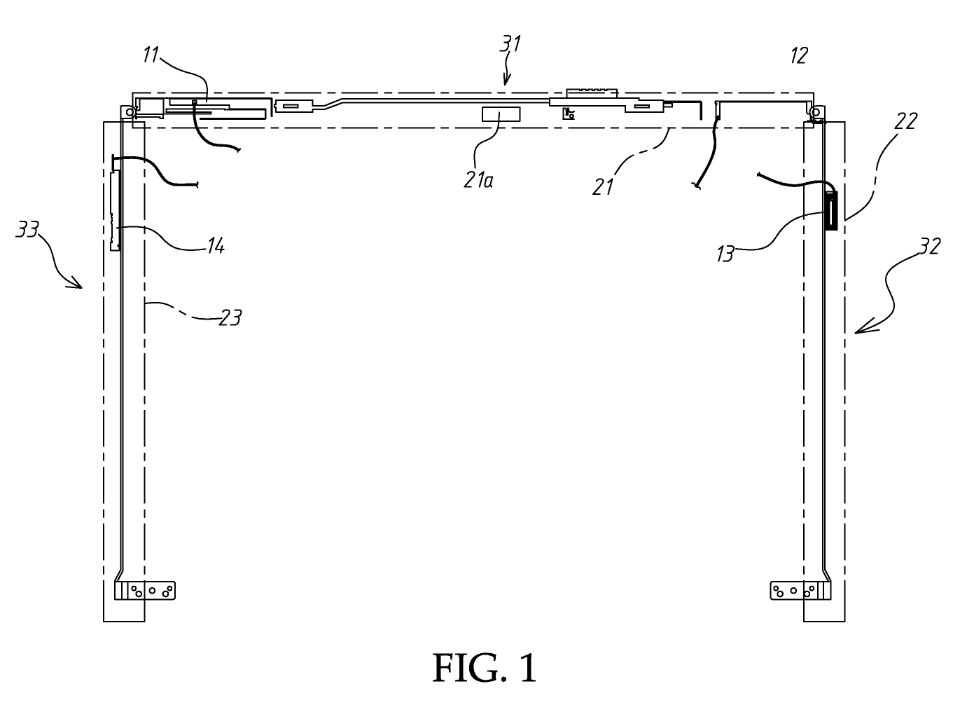

Referring to FIG. 1 which shows the first step of the present invention to design to use a mode of manufacturing labels to make groups of or integrate a plurality of antennas required by the notebook, to thereby make a label type antenna; in the step, mainly a first label film 21 is made to get a first planar antenna 11 of the type of WWAN/GPS and WiMAX/WLAN, and to get a second planar antenna 12 of the type of WiMAX/WLAN and WALN, they are designed to be on the housing of a display screen of the notebook; and a second label film 22 is made to get a third planar antenna 13 of the type of FM, it is designed to be on the right side of the housing of the display screen of the notebook; a third label film 23 is made to get a fourth planar antenna 14 of the type of UWB and Bluetooth. And there are an upper label type antenna section 31, a right label type antenna section 32 and a left label type antenna section 33 that can be manufactured in a mode of making groups or integrating.

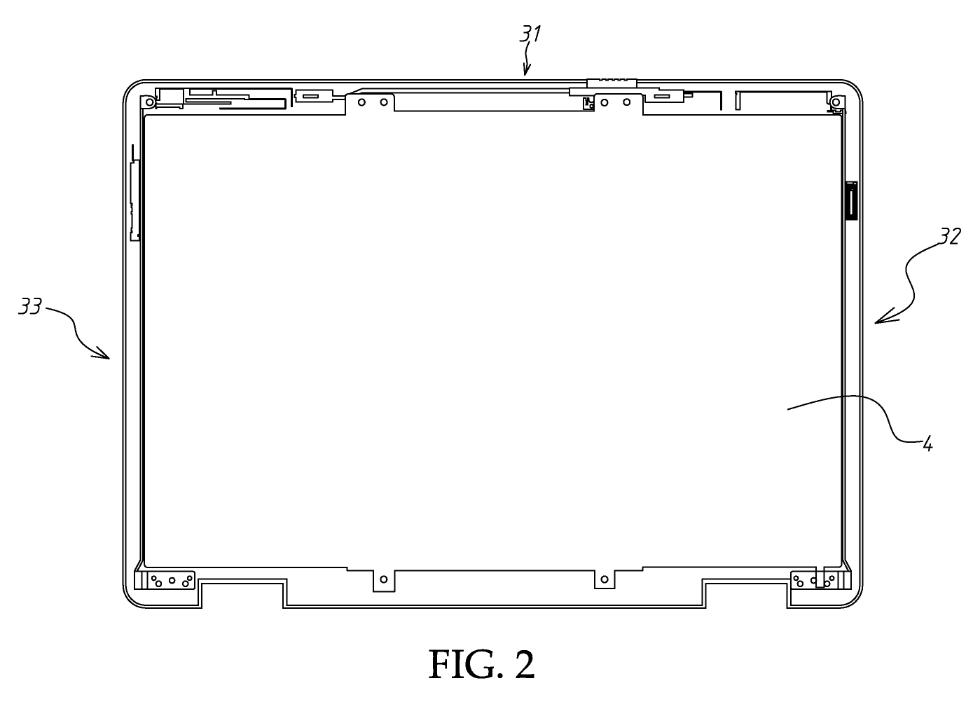

In FIG. 2 which shows that the label type antenna sections 31, 32 and 33 of the present invention are stuck and fixed on of a periphery on an inner layer of the housing of the notebook, for instance on an inner layer of a housing 4 around a display screen.

In installation by the method of the present invention, it needs only to stick the label type antenna made on their respective correct places to complete the installation, and no fixing means such as using screws is required; this will make antenna installation very easy and fast, and can reduce cost and thickness and weight of notebooks.

And more, the steps of manufacturing a label of the present invention are:
A) cutting metallic sheet: to cut a metallic sheet to get at least a metallic radiation layer;
B) applying glue: to form a first adhesive layer on one side of each of the aforesaid at least a metallic radiation layer;
C) shaping a label film: shaping by punching molding;
D) positioning and press combining: using a set of press combining equipment to stick uniformly the label films on the aforesaid at least a metallic radiation layer, and eliminating air bubbles;
E) applying glue: to form a second adhesive layer on another side of each of the aforesaid at least a metallic radiation layer;
F) sticking a releasing paper on: the paper being stuck on the second adhesive layers; and
G) cutting out contour: to cut out the contour of a label type antenna formed.

In practical installation, the releasing paper on the label type antenna is torn off and stuck on an inner layer of the housing of the notebook.

In manufacturing the label type antenna of the present invention, the label type antenna can be provided further with at least an opening 21a to leave a space for the peripheral equipment (such as a camera module, a set of horns etc.) of the notebook of the present invention. And each antenna of the label type antenna is connected respectively to a signal line, and all the signal lines of the label type antenna can be combined into one soft bus line in favor of connecting different communication equipment. The label type antenna of the present invention can be a structure with a monolayer or multiple layers.

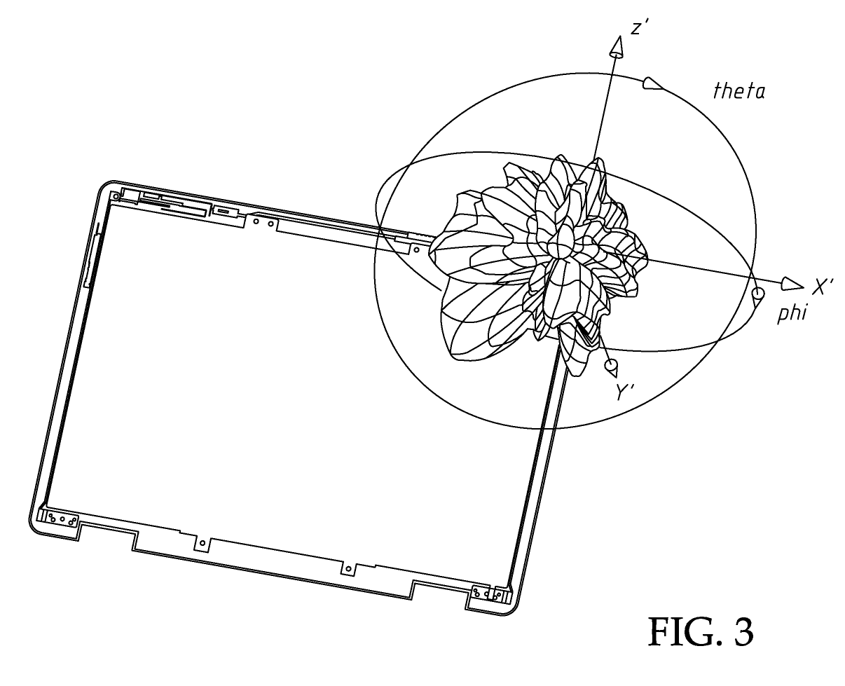

Referring to FIG. 3, it shows a pattern diagram of 3D field type obtained by a simulation test.

The preferred embodiment is only for illustrating the present invention, and not for giving any limitation to the scope of the present invention. It will be apparent to those skilled in this art that various modifications or changes such as increasing or reducing of the amount of planar antenna or positions allocated for them shall also fall within the scope of the appended claims.

1. A method of installation of notebook antennas comprising steps of:
a) to design to use a mode of manufacturing labels to make groups of or integrate a plurality of antennas required by a notebook, and to make a label type antenna; and
b) then to stick and fix said label type antenna on an inner layer of a housing of said notebook.

2. The method of installation of notebook antennas as defined in claim 1, wherein steps of manufacturing said label are:
A) cutting metallic sheet: to cut a metallic sheet to get at least a metallic radiation layer;
B) applying glue: to form a first adhesive layer on one side of each of said at least a metallic radiation layer;
C) shaping a label film: shaping by punching molding;
D) positioning and press combining: using a set of press combining equipment to stick uniformly said label films on said at least a metallic radiation layer, and eliminating air bubbles;
E) applying glue: to form a second adhesive layer on another side of each of said at least a metallic radiation layer;
F) sticking a releasing paper on: said paper being stuck on said second adhesive layers; and
G) cutting out contours: to cut out contours of a label type antenna formed.

3. The method of installation of notebook antennas as defined in claim 2, wherein said label type antenna is provided with at least an opening.

4. The method of installation of notebook antennas as defined in claim 2, wherein each antenna of said label type antennas is connected respectively to a signal line.

5. The method of installation of notebook antennas as defined in claim 4, wherein all said signal lines of said label type antennas are combined into one soft bus line.

6. The method of installation of notebook antennas as defined in claim 1, wherein said label type antenna has a monolayer.

7. The method of installation of notebook antennas as defined in claim 1, wherein said label type antenna has multiple layers.

8. The method of installation of notebook antennas as defined in claim 1, wherein said label type antenna is laid out on of a periphery around a display screen of said notebook.
